(19) United States
(12) Patent Application Publication
(10) Pub. No.: US 2026/0193543 A1
(43) Pub. Date: Jul. 9, 2026

(54) PROCESS FOR SYNTHESISING HYDROCARBONS

(71) Applicant: JOHNSON MATTHEY DAVY TECHNOLOGIES LIMITED, London (GB)

(72) Inventors: Roger Kenneth BENCE, London (GB); Henry Arthur CLAXTON, London (GB); Andrew James COE, London (GB); Amelia Lorna Solveig COOK, London (GB); Michiel NIJEMEISLAND, Billingham Cleveland (GB); Paul Robert TICEHURST, London (GB)

(21) Appl. No.: 19/132,246

(22) PCT Filed: Nov. 21, 2023
(86) PCT No.: PCT/GB2023/053036

§ 371 Date: May 22, 2025

(30) Foreign Application Priority Data
Jan. 13, 2023 (GB) 2300515.0

(51) Int. Cl. C10G 2/00; C01B 3/02

(52) U.S. Cl. CPC C10G 2/331; C01B 3/02; C01B 2203/0283; C01B 2203/062; C01B 2203/1052; C10G 2300/1003; C10G 2300/1011

(57) ABSTRACT

A process for synthesising hydrocarbons comprising the steps of: (a) feeding a gas mixture comprising hydrogen and carbon dioxide to a reverse water-gas shift unit to form a crude synthesis gas comprising hydrogen, carbon monoxide carbon dioxide and steam, (b) cooling the crude synthesis gas to condense water and removing water, and optionally carbon dioxide, from the crude synthesis gas to produce a feed stream comprising hydrogen and carbon monoxide, (c) passing the feed stream though a hydrocarbon synthesis unit comprising a reactor containing a Fischer-Tropsch catalyst to form a product stream comprising a mixture of liquid hydrocarbons, a co-produced water stream, and a tail gas stream containing hydrogen, carbon monoxide and gaseous hydrocarbons, and (d) upgrading the product stream in an upgrading unit to produce an upgraded product stream, wherein a naphtha stream is separated from the product stream or the upgraded product stream.

### FIELD

This invention relates to a process for synthesising hydrocarbons from synthesis gas comprising hydrogen and carbon monoxide prepared using a reverse water-gas shift reaction.

### BACKGROUND

Processes for synthesis of hydrocarbons from synthesis gas comprising hydrogen and carbon monoxide prepared using a reverse water-gas shift reaction are known. For example, WO2022/079407 A1 discloses a process for synthesising hydrocarbons wherein at least a portion of a carbon dioxide stream recovered from a carbon dioxide removal unit and a portion of a hydrogen stream produced by an electrolysis unit are fed to a reverse water-gas shift unit to produce a carbon monoxide stream, and at least a portion of the carbon monoxide stream from the reverse water-gas shift unit is fed to a Fischer-Tropsch hydrocarbon synthesis unit. A tail gas comprising one or more of methane, ethane, propane, butane and C5-C10 hydrocarbons, may be recovered from the Fischer-Tropsch hydrocarbon synthesis unit and subjected to a separate derichment step, to form a deriched tail gas. The deriched tail gas may be fed to the Fischer-Tropsch hydrocarbon synthesis unit, and/or the reverse water-gas shift unit.

### SUMMARY

We have realised that the process efficiency may be enhanced by adding at least a portion of the tail gas and a portion of a naphtha stream recovered from the hydrocarbon synthesis unit or upgrading unit to the derichment stage, to produce a methane containing gas for use in the reverse water-gas shift unit to produce additional synthesis gas. We have further realised that in order to efficiently utilise the tail gas and naphtha fractions, different derichment vessels and conditions are required.

Accordingly, the invention provides a process for synthesising hydrocarbons comprising the steps of: (a) feeding a gas mixture comprising hydrogen and carbon dioxide to a reverse water-gas shift unit to form a crude synthesis gas comprising hydrogen, carbon monoxide, carbon dioxide and steam, (b) cooling the crude synthesis gas to condense water and removing water (and optionally also removing carbon dioxide) from the crude synthesis gas to produce a feed stream comprising hydrogen and carbon monoxide, (c) passing the feed stream though a hydrocarbon synthesis unit comprising a reactor containing a Fischer-Tropsch catalyst to form a product stream comprising a mixture of liquid hydrocarbons, a co-produced water stream, and a tail gas stream containing hydrogen, carbon monoxide and gaseous hydrocarbons, and (d) upgrading the product stream in an upgrading unit to produce an upgraded product stream, wherein a naphtha stream is separated from the product stream or the upgraded product stream, at least a portion of the tail gas stream is fed with steam to a first derichment vessel containing a derichment catalyst to form a first gas mixture containing methane, at least a portion of the naphtha stream is fed with hydrogen and steam to a second derichment vessel containing a derichment catalyst to form a second gas mixture containing methane, and the first and second gas mixtures containing methane are fed to the reverse water gas shift unit.

The invention further provides a system for performing the process comprising (a) a reverse water-gas shift unit configured to be fed with a gas mixture comprising hydrogen and carbon dioxide, that forms a crude synthesis gas comprising hydrogen, carbon monoxide, carbon dioxide and steam, (b) cooling and separation apparatus configured to be fed with the crude synthesis gas that cools the crude synthesis gas to condense water and remove water (and optionally also remove carbon dioxide) from the crude synthesis gas to produce a feed stream comprising hydrogen and carbon monoxide, (c) a hydrocarbon synthesis unit comprising a reactor containing a Fischer-Tropsch catalyst configured to be fed with the feed stream to form a product stream comprising a mixture of liquid hydrocarbons, a co-produced water stream, and a tail gas stream containing hydrogen, carbon monoxide and gaseous hydrocarbons, and (d) an upgrading unit configured to be fed with the product stream to produce an upgraded product stream, wherein separation equipment is provided to separate a naphtha stream from the product stream or the upgraded product stream, a first derichment vessel containing a derichment catalyst is configured to be fed with at least a portion of the tail gas stream and steam, a second derichment vessel containing a derichment catalyst is configured to be fed with a portion of the naphtha stream, steam and hydrogen, in each case to provide a gas mixture containing methane, and wherein the first and second derichment vessels are coupled to the reverse water-gas shift unit to feed the gas mixtures containing methane from the first and second derichment vessels to the reverse water gas shift unit.

In the present invention, carbon dioxide is combined with hydrogen and used in the reverse water-gas shift unit to form a crude synthesis gas. After cooling, water and optionally carbon dioxide are removed and optionally hydrogen is added to produce a feed gas for a hydrocarbon synthesis unit. The hydrocarbon synthesis unit feeds a hydrocarbon product mixture to an upgrading unit. A naphtha product stream is recovered from the hydrocarbon synthesis unit or upgrading unit. Additionally, a tail gas stream containing unreacted carbon monoxide and hydrogen and a co-produced water stream are recovered from the hydrocarbon synthesis unit. At least a portion of the tail gas stream and a portion of the naphtha stream are fed with steam to two or more derichment vessels containing derichment catalyst that convert C2+ hydrocarbons therein to gas mixtures containing methane, which are fed to the reverse water-gas shift unit. The conditions in the derichment vessels are different and the derichment vessel fed with naphtha is additionally supplied with hydrogen.

### BRIEF DESCRIPTION OF THE DRAWINGS

The invention is illustrated by reference to the accompanying drawing in which:

FIG. 1 depicts a flowsheet of one embodiment of the invention having separate tail gas and upgrader naphtha derichment vessels;

FIG. 2 depicts a flowsheet of a further embodiment of the invention having separate tail gas and upgrader naphtha derichment vessels;

FIG. 3 depicts a flowsheet of a further embodiment of the invention having separate tail gas, hydrocarbon off-gas and upgrader naphtha derichment vessels; and

FIG. 4 depicts a flowsheet of a further embodiment of the invention having separate tail gas and hydrocarbon synthesis unit naphtha derichment vessels.

It will be understood by those skilled in the art that the drawings are diagrammatic and that further items of equipment such as reflux drums, compressors, pumps, vacuum pumps, towers, heat exchangers, temperature sensors, pressure sensors, pressure relief valves, control valves, flow controllers, level controllers, and the like may be required in a commercial plant. The provision of such ancillary items of equipment forms no part of the present invention and is in accordance with conventional chemical engineering practice.

### DETAILED DESCRIPTION

As described in the summary section, the present specification provides a process for synthesising hydrocarbons comprising the steps of: (a) feeding a gas mixture comprising hydrogen and carbon dioxide to a reverse water-gas shift unit to form a crude synthesis gas comprising hydrogen, carbon monoxide carbon dioxide and steam, (b) cooling the crude synthesis gas to condense water and removing water (and optionally carbon dioxide) from the crude synthesis gas to produce a feed stream comprising hydrogen and carbon monoxide, (c) passing the feed stream though a hydrocarbon synthesis unit comprising a reactor containing a Fischer-Tropsch catalyst to form a product stream comprising a mixture of liquid hydrocarbons, a co-produced water stream, and a tail gas stream containing hydrogen, carbon monoxide and gaseous hydrocarbons, and (d) upgrading the product stream in an upgrading unit to produce an upgraded product stream, wherein a naphtha stream is separated from the product stream or the upgraded product stream, at least a portion of the tail gas stream is fed with steam to a first derichment vessel containing a derichment catalyst to form a first gas mixture containing methane, at least a portion of the naphtha stream is fed with hydrogen and steam to a second derichment vessel containing a derichment catalyst to form a second gas mixture containing methane, and the first and second gas mixtures containing methane are fed to the reverse water gas shift unit.

The present specification also provides a system for performing the process comprising (a) a reverse water-gas shift unit configured to be fed with a gas mixture comprising hydrogen and carbon dioxide, that forms a crude synthesis gas comprising hydrogen, carbon monoxide carbon dioxide and steam, (b) cooling and separation apparatus configured to be fed with the crude synthesis gas that cools the crude synthesis gas to condense water and remove water (and optionally carbon dioxide) from the crude synthesis gas to produce a feed stream comprising hydrogen and carbon monoxide, (c) a hydrocarbon synthesis unit comprising a reactor containing a Fischer-Tropsch catalyst configured to be fed with the feed stream to form a product stream comprising a mixture of liquid hydrocarbons, a co-produced water stream, and a tail gas stream containing hydrogen, carbon monoxide and gaseous hydrocarbons, and (d) an upgrading unit configured to be fed with the product stream to produce an upgraded product stream, wherein separation equipment is provided to separate a naphtha stream from the product stream or the upgraded product stream, a first derichment vessel containing a derichment catalyst is configured to be fed with at least a portion of the tail gas stream and steam, a second derichment vessel containing a derichment catalyst is configured to be fed with a portion of the naphtha stream, steam and hydrogen, in each case to provide a gas mixture containing methane, and wherein the first and second derichment vessels are coupled to the reverse water-gas shift unit to feed the gas mixtures containing methane from the first and second derichment vessels to the reverse water gas shift unit.

The reverse water-gas shift unit may comprise any suitable reactor or combination of reactors that conduct the reverse water-gas shift reaction. The reverse water-gas shift unit may comprise a reactor containing a reverse water-gas shift catalyst. Alternatively, the reverse water gas reactor unit may operate non-catalytically, i.e., without a catalyst. The process may therefore comprise subjecting the gas mixture comprising hydrogen and carbon dioxide to a catalytic or non-catalytic reverse-water-gas-shift reaction. The reverse water-gas shift reaction may be depicted as follows:

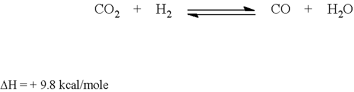

The reverse water-gas shift process therefore is favoured at high temperatures. The reverse water gas shift reactor may be plasma-heated or electrically-heated. The gas mixture comprising hydrogen and carbon dioxide may therefore be subjected to an electrically heated reverse-water-gas-shift reaction or a plasma-heated reverse-water-gas-shift reaction. The gas mixture comprising hydrogen and carbon dioxide may be subjected to an autothermal reverse-water-gas-shift reaction. A particularly preferred reverse water-gas shift unit comprises an autothermal shift reactor in which hydrogen and carbon dioxide are fed as a mixture or separately to a burner inside a reverse water-gas shift vessel where they are partially combusted with oxygen to generate a heated gas comprising hydrogen, steam, carbon monoxide and carbon dioxide that passes through a bed of reverse water gas shift catalyst disposed downstream of the burner. Such an arrangement is described in WO2022/079408 A1. Hydrogen is combusted in the reverse water-gas shift vessel to generate heat for the reverse water-gas shift reaction. Accordingly, in this arrangement hydrogen should be provided in excess of the carbon dioxide so that sufficient hydrogen remains after combustion to drive the reaction forward over the reverse water-gas shift catalyst. Excess hydrogen is also desirable in view of the potential end use of the carbon monoxide-containing gas in the Fischer-Tropsch synthesis of hydrocarbons where the H₂:CO ratio is desirably about 2:1. The molar ratio of hydrogen to carbon dioxide in the gas mixture fed to the burner may be in the range of 1:1 to 5:1. The ratio may vary depending on the conversion of the carbon dioxide achieved in the reverse water-gas shift unit and the desired hydrogen to carbon monoxide ratio for the downstream process.

The gas mixture comprising carbon dioxide and hydrogen fed to the burner may comprise 15 to 50% by volume, preferably 25 to 40% by volume, of carbon dioxide. The gas mixture comprising carbon dioxide and hydrogen fed to the burner preferably comprises less than 10% by volume in total of other gases, such as steam, nitrogen, carbon monoxide and methane.

Any suitable source of hydrogen may be used. More than one source of hydrogen may be used. The process preferably utilises non-fossil fuel based hydrogen. Accordingly, the hydrogen may be generated by catalytic or non-catalytic partial oxidation of biomass or plastics, optionally followed by steam reforming of the partial oxidation product gases. Alternatively, the hydrogen may be provided by splitting water. Preferably, the hydrogen is electrolytic hydrogen, for example hydrogen formed by electrolysis of water. Intermediate storage of the hydrogen may be used to reduce any variability in production of hydrogen from the electrolysis. In some embodiments the co-produced water from the hydrocarbon synthesis unit may be subjected to electrolysis to produce an electrolysis hydrogen stream used in the process. Such water electrolysis may conveniently use electricity from renewable sources such as solar, wind or tidal power. By using renewable electricity, the overall carbon intensity of the process can be negative, resulting in overall negative carbon dioxide emissions.

Any suitable source of carbon dioxide may be used. Thus, the carbon dioxide stream may be a stream recovered from a conventional ammonia plant that uses a hydrocarbon or carbonaceous feed, or the carbon dioxide stream may be one recovered from a furnace or boiler flue gas, wherein the furnace or boiler is heated by combustion of a carbonaceous fuel, such as natural gas or coal, biomass, or carbonaceous wastes, such as plastics. Alternatively, the carbon dioxide may be a CO₂ stream separated from air or seawater. Preferably, at least a portion of the carbon dioxide is recycled from downstream of the reverse water-gas shift unit, for example following treatment of the crude synthesis gas in a carbon dioxide removal unit and/or a downstream process that generates carbon dioxide as a by-product, such as a Fischer-Tropsch hydrocarbon synthesis unit.

In some arrangements, the carbon dioxide may at least in part be recovered from a synthesis gas stream generated by a synthesis gas generation unit upstream of the reverse water-gas shift unit. This has the advantage that the synthesis gas generation unit provides additional hydrogen and carbon monoxide for use in the hydrocarbon synthesis unit.

The synthesis gas generation unit may be any unit that converts a feedstock into a synthesis gas comprising hydrogen, carbon monoxide and carbon dioxide. Depending on the nature of the feedstock various syngas generation technologies may be preferred. For example, where the feedstock is natural gas, the synthesis gas generation unit preferably comprises a catalytic partial oxidation unit, a non-catalytic partial oxidation unit or an autothermal reformer. Alternatively, where the feedstock is coal, biomass or municipal solid waste or equivalent containing non-biogenic carbon, the synthesis gas generation unit preferably comprises a gasifier. Any known gasification technology may be used. Preferably, the gasification is carried out by partial oxidation, which comprises combusting the feedstock under sub-stoichiometric conditions at high temperature, generally between 800° C. and 1600° C., with air or oxygen in order to obtain a crude synthesis gas. When a nitrogen-free synthesis gas is desired, this process uses oxygen. Gasification produces synthesis gas and a residual fraction comprising tar oils. The synthesis gas is generally a gas mixture comprising carbon monoxide, hydrogen, water vapour and carbon dioxide. In addition, it typically will comprise sulphur-comprising, nitrogen-comprising and halogen-comprising impurities. Common sulphur-containing impurities are carbonyl sulphide (COS) and hydrogen sulphide (H₂S). These impurities, where present, are desirably removed upstream of the Fischer-Tropsch hydrocarbon synthesis unit using one or more contaminant removal stages by washing (absorption), by passing the crude synthesis gas through one or beds of a suitable adsorbent, or by a mixture of these. Synthesis gas purification may be performed in one or more stages before and/or after the carbon dioxide removal unit.

The reverse water-gas shift unit and synthesis gas generation unit, if present, may use oxygen. Oxygen may be recovered from air using an air separation unit (ASU), which may be driven by renewable power sources or steam raised in the reformed gas boiler or other sources, including from downstream processes. Preferably, the oxygen used in the process comprises electrolytic oxygen, for example oxygen formed by the electrolysis of water in an electrolysis unit. This has the benefit of reducing the capital investment in an air separation plant and/or reduces the power consumption by an air separation plant, if required.

Hydrogen and oxygen for the process are therefore both preferably generated using an electrolysis unit to which a source of water is fed. The water may include condensate recovered from the crude synthesis gas mixture produced by the reverse water-gas shift unit, or in an upstream syngas generation unit, and/or may comprise the water recovered from a downstream conversion unit such as a Fischer-Tropsch hydrocarbon synthesis unit. If required, the water may be treated to remove contaminants, such as organic compounds or salts, that would adversely affect the electrolysis unit.

The electricity for the electrolysis unit is desirably not obtained from the combustion of fossil fuels. The electrical power for the electrolysis may be provided by nuclear power or preferably, by renewable power sources, such as photovoltaic solar energy, wind energy, tidal energy, waterpower or hydroelectricity, marine energy sources, geothermal energy and/or biomass. The electricity for the electrolysis may also be provided using a turbine driven by steam generated using heat recovered from product gas streams created by the partial oxidation of biomass or plastic waste. Electrical power may be stored in an intermediate facility such pumped hydro- or battery-storage to provide a more constant supply of electrical power to the electrolysis unit.

The carbon dioxide and hydrogen streams or the gas mixture comprising the carbon dioxide and hydrogen may, if required, be compressed to a pressure in the range of 0.8 to 6.5 MPag, preferably 1.2 to 5.5 MPag.

Before, but preferably after compression, the gas streams fed to the reverse water-gas shift unit may be preheated. The pre-heat temperature of the feed gases to an autothermal reverse water-gas shift vessel are preferably in the range of 400 to 1000° C., preferably 450 to 800° C. to sustain combustion and minimise carbon formation. The hydrogen and carbon dioxide streams may be premixed before preheating or preheated and mixed. Preheating of the feeds to their pre-heat temperatures may be done by interchange with the crude synthesis gas mixture, and/or by steam heating, or by using a fired heater or by electrical heating or by a combination of two or more these. Preferably, the feed gas mixture comprising carbon dioxide and hydrogen is heated by interchange with the crude synthesis gas mixture, optionally supplemented by electrical heating.

In the present invention, carbon dioxide is converted to carbon monoxide by subjecting it to the reverse water-gas shift reaction in a reverse water-gas shift unit comprising a reverse water-gas shift vessel containing a reverse-water-gas shift catalyst.

A preferred reverse water-gas shift unit comprises an autothermal reverse water-gas shift vessel containing a burner and a fixed bed of the reverse water-gas shift catalyst. The burner is fed with the carbon dioxide containing gas and an oxygen stream and combusts a portion of the hydrogen and any hydrocarbons present in the carbon dioxide-containing gas, thereby generating heat for the endothermic reverse water-gas shift reaction.

The oxygen and the gas mixture comprising carbon dioxide and hydrogen are fed to a burner disposed in a reverse water-gas shift vessel. Any burner design may be used, such as burners used in autothermal reformers. Combustion generates a flame in a combustion zone upstream of the catalyst within the reverse water-gas shift vessel. The localized conditions in the combustion section, especially in the flame front region, may be controlled by managing the momentum of the oxidant and gas streams. The water-gas shift vessel may be orientated such that the combustion zone is above the bed of reverse water-gas shift catalyst. Such arrangements are used in autothermal reforming vessels and may be used in the present process, which may be termed autothermal reverse water-gas shift. Other arrangements of the burner and catalyst may however also be used.

The gas mixture is heated by the combustion to a temperature typically in the range of 800 to 1300° C. Oxygen is consumed. The heated gas mixture comprising carbon monoxide, carbon dioxide, steam, and unreacted hydrogen is then passed through a bed of reverse water-gas shift catalyst disposed within the reverse water-gas shift vessel downstream of the burner.

The reverse water-gas shift catalyst may be any suitable transition metal oxide catalyst, for example a catalyst based on nickel oxide, iron oxide or on chromium oxide, but other catalysts used as reverse water-gas shift catalysts may be used. Preferably the catalyst is a nickel-oxide based catalyst. Such catalysts are active for the reverse water-gas shift catalyst but advantageously will also steam reform methane provided by the derichment vessels and present in the gas mixture comprising hydrogen and carbon dioxide. The catalyst therefore preferably comprises nickel oxide on a suitable refractory metal oxide support. The refractory metal oxide support may comprise zirconia, alumina, calcium aluminate, magnesium aluminate, titania magnesia, or mixtures thereof. More preferably, the catalyst comprises nickel oxide on zirconia, nickel oxide on alpha-alumina, nickel oxide on calcium aluminate or nickel oxide on magnesium aluminate. The nickel content may be in the range of from 3 to 20% by weight, expressed as NiO.

The reverse water-gas shift catalyst may be particulate, for example in the form of shaped units such as pellets, rings or extrudates, which may be lobed or fluted. The catalytically active metal, e.g. nickel, may be dispersed throughout the particulate catalyst or present only within an eggshell layer of thickness 200 to 1000 micrometres on the surface of the refractory support. Alternatively, catalyst may comprise one or more monolithic supports such as a metal or ceramic foam or honeycomb supporting the catalytically active metal. Preferably, the catalyst is a particulate catalyst, more preferably 4-hole cylinder, particularly one that is a lobed or fluted to provide a higher geometric surface area (GSA) than a similarly sized solid cylinder. Catalysts having a GSA in the range 400-550 m² per cubic metre are preferred.

If desired, a layer of zirconia balls, pellets or tiles may be placed on top of the reverse water-gas shift catalyst to protect the surface of the catalyst from irregularities in the combusting gas flow. A benefit of providing this layer is to prevent disturbance of the surface of the catalyst bed.

By controlling the pre-heat temperature and the amount of oxygen fed to the burner, it is possible to control the exit temperature of the reverse water-gas shift vessel. The exit temperature may be in the range 700° C. to 1050° C., preferably 750 to 950° C.

In the present invention, in addition to producing the carbon monoxide gas stream by the reverse water-gas shift reaction, the reverse water-gas shift vessel is used to convert methane generated from waste streams from downstream processes into carbon monoxide. The reverse water-gas shift vessel is therefore fed with methane-containing gas streams from the first and second derichment vessels. The first derichment vessel is fed with at least a portion of a tail gas recovered from the Fischer Tropsch hydrocarbon synthesis unit. The second derichment vessel is fed with a portion of the naphtha recovered from the hydrocarbon synthesis unit or an upgrading unit coupled to the hydrocarbon synthesis unit.

The derichment vessels operate by adiabatically steam reforming hydrocarbons in the tail gas and naphtha streams. Accordingly, a supply of steam to the derichment vessels is also required. Furthermore, in order to satisfactorily steam reform the naphtha without deactivation of the catalyst by carbon formation, a source of hydrogen is also provided to the second derichment vessel.

In the present invention at least a portion of the tail gas stream is fed with steam to a first derichment vessel containing a derichment catalyst to form a gas mixture containing methane, and at least a portion of the naphtha stream is fed with hydrogen and steam to a second derichment vessel containing a derichment catalyst to form a second gas mixture containing methane. The steam introduction may be effected by direct injection of steam and/or by saturation of the feed gas by contact with a stream of heated water. The heated water may comprise condensed water from a downstream process that contains soluble organic compounds. Alternatively, the steam used for direct injection may have been used to strip organic compounds from condensed water from a downstream process. In this way, the organic compounds may be converted to hydrogen and carbon oxides in the derichment vessel and the burden of waste water treatment for the downstream process may be reduced.

The amount of steam introduced may be such as to give a steam to carbon molar ratio in the feeds to the derichment vessels of 0.1:1 to 5:1. By steam to carbon molar ratio we mean the molar ratio of steam to the sum of the carbon-containing components in the feed, including hydrocarbons, CO and CO₂.

The derichment vessels feed gases, typically have inlet temperatures in the range of 250-650° C. The feed gases may be passed adiabatically through a bed of a derichment catalyst, such as a particulate nickel catalyst having a high nickel content, for example above 40% by weight. Such catalysts are available commercially. The same or a different catalyst may be used in the first and second derichment vessels.

A stream of hydrogen is fed with the naphtha to the second derichment vessel to reliably convert naphtha to methane. The hydrogen may be a pure hydrogen stream or may comprise a suitably high hydrogen content to provide the hydrogen for the derichment. In some embodiments a pure hydrogen stream may be supplemented with hydrogen-containing off gas from the hydrocarbon synthesis unit and/or the upgrading unit.

During the derichment step, any hydrocarbons higher than methane react with steam to give a mixture of methane, carbon oxides and hydrogen.

In some arrangements the first derichment vessel operates with an inlet temperature in the range of 250-650° C., preferably 300-400° C. and a steam to carbon molar ratio of 0.1:1 to 5:1.

If desired, the first derichment vessel may be operated at a pressure in the range of 1.0 to 7.0 MPag, preferably 1.5 to 6.6 MPag.

In some arrangements the second derichment vessel operates with an inlet temperature in the range 400-550° C., a steam to carbon molar ratio of 1:1 to 5:1 and a minimum H₂ content of 0.001 kg H₂ per kg of carbon-containing components in the feed.

If desired, the second derichment vessel may be operated at a pressure in the range of 1.0 to 7.0 MPag, preferably 1.5 to 6.6 MPag. The operating pressure of the first and second derichment vessels may be the same or different.

Generating methane-containing gas mixtures is preferred over feeding the tail gas, hydrocarbon off-gas and naphtha streams directly to the reverse water-gas shift unit because it reduces the risk of unwanted carbon formation in the reverse water-gas shift vessel or on the reverse water-gas shift catalyst.

In the present invention, the gas mixtures containing methane recovered from the derichment vessels are fed to the reverse water-gas shift unit. The gas mixtures containing methane may be fed separately from the derichment vessels to the reverse water-gas shift unit or mixed with one or both of the hydrogen and carbon dioxide feed streams. The gas mixtures containing methane may optionally be preheated. The gas mixtures containing methane may be preheated separately or once combined with the hydrogen and carbon dioxide stream feeds. When using an autothermal reverse water-gas shift reactor, the gas mixtures containing methane may be pre-heated to a temperature in the range of 400 to 1000° C., preferably 450 to 800° C. to sustain combustion and minimise carbon formation.

The hydrocarbon synthesis unit produces a product stream that is upgraded in the upgrading unit. The product stream comprises a mixture of gaseous and liquid hydrocarbons. In some arrangements, it is possible to separate a hydrocarbon synthesis unit naphtha stream from the product stream upstream of the upgrading unit. The naphtha stream may be recovered by cooling the product stream and separating it using one or more vapour-liquid separators. The naphtha stream recovered from the hydrocarbon synthesis unit typically comprises of a mixture of C3 to C9 hydrocarbons with an approximate final boiling point of less than 240° C.

In addition, the hydrocarbon synthesis unit may be operated to produce a hydrocarbon synthesis unit hydrocarbon off-gas stream by physical separation of light gaseous hydrocarbons, e.g. C1, C2, C3 and C4 hydrocarbons, from heavier liquid hydrocarbons and co-produced water fed to one or more vapour-liquid separators in the FT unit.

The upgrading unit may be configured to produce an upgrader naphtha stream from the product stream. The upgrader naphtha stream may be recovered in the upgrading unit from one or more distillation columns in which feeds are heated and hydrocarbons separated based on their boiling points. The naphtha product stream recovered from the upgrading unit typically comprises saturated hydrocarbons typically C5 to C11 with a boiling point in the range 30 to 220° C.

Generally, it will be either the naphtha from the hydrocarbon synthesis unit or the naphtha from the upgrading unit that will be fed to the second derichment vessel. Hence, the naphtha stream from the hydrocarbon synthesis unit or the upgrading unit may be compressed, vapourised, mixed with steam and hydrogen and fed to the second derichment vessel.

The upgrading unit may be configured to additionally produce an upgrader hydrocarbon off-gas stream. The upgrader hydrocarbon off-gas stream may be recovered in the upgrading unit from a let-down vessel in which pressure of a mixed hydrocarbon feed is reduced causing light hydrocarbons to flash or volatilise, or from one or more distillation columns in which feeds are heated and hydrocarbons separated based on their boiling points. The let-down vessel and one or more distillation columns may be downstream of a hydrotreating unit. The upgrader off-gas will typically comprise saturated hydrocarbons, hydrogen, methane, carbon monoxide, carbon dioxide and inert contaminants such as nitrogen.

One or both of the hydrocarbon off-gas streams may usefully be recycled to the process to further improve carbon efficiency of the process and minimise carbon-containing streams sent to fuel where they would ultimately lead to carbon dioxide emissions. As the off-gas streams may be produced at similar pressures it may be advantageous to compress them together rather than individually prior to being fed to the derichment vessel.

Accordingly, the upgrader hydrocarbon off-gas and optionally the hydrocarbon synthesis unit hydrocarbon off-gas may also be fed to the first derichment vessel and/or the second derichment vessel. Alternatively, one or more further derichment vessels may be provided for treatment of one or both of the hydrocarbon off-gas streams. The destination of the off-gas streams will depend on the proportion of C2, C3 and C4 hydrocarbons present when combining the streams with the tail gas or the naphtha stream. It may be advantageous for operational flexibility and optimised operating conditions to feed the off-gas to a third derichment vessel. Thus, in some arrangements, a third derichment vessel containing a derichment catalyst is fed with at least a portion of the upgrader hydrocarbon off gas, steam and optionally a portion of the hydrocarbon synthesis unit hydrocarbon off-gas, to produce a further gas mixture containing methane that is fed to the reverse water gas shift unit. If desired a hydrogen stream may also be provided to the one or more further derichment vessels to improve derichment of the off-gas stream.

In some arrangements, the one or more further derichment vessels may be configured to operate with an inlet temperature in the range 300-500° C., a steam to carbon molar ratio of 1:1 to 5:1 and a minimum H₂ content of 0.001 kg H₂ per kg of carbon-containing components in the feed.

If desired, the one or more further derichment vessels may be operated at a pressure in the range of 1.0 to 7.0 MPag, preferably 1.5 to 6.6 MPag. The pressure of the one or more further derichment vessels may be the same or different from the first and second derichment vessels.

The upgrading unit may also be operated to additionally produce a light hydrocarbon liquid stream that, if desired, may be recycled to the first, second or one or more further derichment vessels. The light hydrocarbon liquid stream will primarily comprise of C3 and C4 saturated hydrocarbons. If used, the light hydrocarbon liquid will require compression and vaporisation prior to being fed to one or more further derichment vessels.

The proportions of the naphtha, tails gas, off-gas and light hydrocarbon streams fed to the derichment vessels will vary depending on the product slate produced from the upgrading unit and on the recycle ratio of tail gas within the hydrocarbon synthesis unit. It is expected that the proportion of tail gas by mass will be greater than the off-gas streams, with sufficient hydrogen contained in the tail gas to require no further hydrogen addition to the first derichment vessel if fed also with the off-gas.

If sulphur contaminants are present in the naphtha and upgrader hydrocarbon off-gas streams in the upgrading unit, these may be removed, preferably after compression, by subjecting the naphtha and upgrader off-gas stream to a step of desulphurisation upstream of the derichment step. This may be accomplished using any suitable desulphurisation method, such as including absorbing the sulphur compounds by passing the streams through beds of zinc oxide absorbents.

The upgrader hydrocarbon off-gas may be recovered at a pressure in the range 0.1 to 1.0 MPag. The hydrocarbon synthesis unit hydrocarbon off-gas may be recovered at a pressure in the range 0.1 to 1.0 MPag. If desired, the upgrader hydrocarbon off-gas and the hydrocarbon synthesis unit hydrocarbon off-gas may be compressed to a pressure in the range 1.0 to 7.0 MPag. The off gases may be compressed separately or preferably combined and compressed.

The gas mixtures containing methane from the first, second and one or more further derichment vessels will contain unreacted steam. It is usually not necessary to do so, but if desired the steam may be condensed by cooling the deriched gas mixtures to below the dew point and recovering condensate to produce de-watered deriched gas feed to the reverse water gas shift unit. Removing the steam may improve the reverse water-gas shift equilibrium. The recovered condensate may usefully be used to generate steam for the process or used to generate hydrogen by electrolysis of water.

The gas mixtures containing methane may be compressed, if desired before feeding to the inlet of the reverse water-gas shift unit. Compression may be performed before or preferably after any de-watering step.

The gas mixture feed comprising hydrogen and carbon dioxide for the reverse water-gas shift unit may be preheated and combined with the methane-containing gas streams from the derichment vessels. Alternatively, methane-containing gas streams may be optionally preheated and fed separately to the reverse water gas shift reactor.

The reverse water gas shift unit converts carbon dioxide to carbon monoxide and consumes some hydrogen by the reverse water gas shift reaction described above. The reverse water-gas shift unit generates a crude synthesis gas mixture.

The crude synthesis gas mixture from the reverse water-gas shift vessel comprises steam formed by the reverse water-gas shift reaction and possibly steam added with the gas mixtures containing methane. Water is recovered from the crude synthesis gas mixture by cooling the product gas mixture to below the dew point and separating condensate, e.g. using one or more conventional gas-liquid separators. Removing water condensate from the crude synthesis gas mixture produces a dewatered product gas. The cooling may be performed by raising steam and/or by preheating one or more of the hydrogen stream, the carbon dioxide stream, the mixed gas stream comprising hydrogen and carbon dioxide, and optionally the derichment vessels feed gases. Further cooling with cold water and/or air may also be performed. Process steam generated by the cooling may be used in the derichment step or in downstream processes and/or for power generation.

The condensed water may, if desired, be recycled at least in part to the process. The condensate may be used, after treatment if desired, be used as boiler feed water. In addition, or alternatively, the condensate, optionally after treatment to use contaminants, may be fed to an electrolysis unit used to generate hydrogen for the process. Accordingly, in some embodiments, a water stream recovered from the crude synthesis gas mixture may be fed to an electrolysis unit. Condensate may also be used, again after treatment if desired, as a boiler feed water.

The crude synthesis gas mixture contains carbon dioxide, which is removed from the dewatered product gas using a carbon dioxide removal unit. The majority of the carbon dioxide may be separated by membrane, solid absorbent or, preferably, a wash system, such as a system operating by counter current contact of the crude synthesis gas mixture or dewatered product gas with absorbent liquid over packing in a tower. The absorbent liquid can be a physical solvent such as potassium carbonate (sold as the Benfield process), methanol (sold as the Rectisol process) or glycols (sold as the Selexol process) or chemical solvents such as amines. The carbon dioxide removal unit may therefore include one or more vessels providing a physical wash system or a reactive wash system, preferably a reactive wash system, especially an amine wash system. The carbon dioxide may be removed by a conventional acid gas recovery unit (AGRU). In a conventional AGRU, a de-watered gas stream is contacted with a stream of a suitable absorbent liquid, such as an amine, for example an aqueous solution comprising monoethanolamine (MEA), methyldiethanolamine (MDEA) or dimethylethanolamine (DMEA), particularly methyl diethanolamine (MDEA), so that the carbon dioxide is absorbed by the liquid to give a laden absorbent liquid and a gas stream having a decreased content of carbon dioxide. The laden absorbent liquid is then regenerated by heating and/or reducing the pressure to desorb the carbon dioxide and to give a regenerated absorbent liquid, which is then recycled to the carbon dioxide absorption stage. Heat from the regeneration of the laden absorbent may be recovered from within the process. For example, a portion of the crude synthesis gas mixture or steam generated by cooling the crude synthesis gas mixture may be used to heat the laden absorbent.

Alternatively, in place of the washing with amines, cold methanol or a glycol may be used in a similar manner as the amine to remove the carbon dioxide.

The recovered carbon dioxide obtained from the carbon dioxide removal unit is preferably recompressed as required and returned to the reverse water-gas shift vessel to increase the overall conversion to carbon monoxide.

The recovered carbon dioxide may be combined with the carbon dioxide feed, the hydrogen gas feed or the gas mixture containing hydrogen and carbon monoxide before pre-heating. It is preferably combined with the carbon dioxide feed stream before compression thereof.

The removal of carbon dioxide from the dewatered product gas produces a gas stream comprising carbon monoxide. Hydrogen will also be present in the product gas with the amount depending on the excess of hydrogen fed to the reverse water-gas shift vessel. If desired, one or more purification units may be provided downstream of the carbon dioxide removal unit to remove contaminants from the gas stream comprising carbon monoxide.

The gas stream comprising carbon monoxide comprises carbon monoxide and hydrogen. The hydrogen to carbon monoxide molar ratio may be in the range 1.0 to 2.5:1, preferably 1.2 to 2.5:1, more preferably 1.6 to 2.2, which is particularly suitable for hydrocarbon synthesis by the Fischer-Tropsch reaction.

In the present invention, the product gas is fed to a Fischer-Tropsch hydrocarbon synthesis unit that synthesises a mixture of hydrocarbon products.

The Fischer-Tropsch hydrocarbon synthesis unit may comprise one or more Fischer-Tropsch reaction vessels containing a Fischer-Tropsch catalyst. The Fischer-Tropsch conversion stage can be carried out according to any one of the known processes, using any one of the known catalysts, but is advantageously applied to processes using cobalt catalysts.

The Fischer-Tropsch process involves a series of chemical reactions that produce a variety of hydrocarbons, ideally having the formula (CₙH₂ₙ₊₂). The more useful reactions produce alkanes as follows:

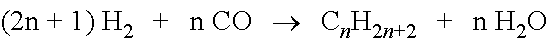

where n is typically 5-100 or higher, with preferred products having n in the range 10-20.

The Fischer-Tropsch reaction may be performed using one or more reactors such as fixed-bed reactors, slurry-phase reactors, bubble-column reactors, loop reactors or fluidised bed reactors. The process may be operated at pressures in the range 0.1 to 10 MPa and temperatures in the range 170 to 350° C. The gas-hourly-space velocity (GHSV) for continuous operation is in the range 1000 to 25000 hr⁻¹. Preferably the Fischer-Tropsch synthesis is carried out using one or more fixed bed reactors, i.e. a reaction vessel with a bed of catalyst fixed within the vessel through which the purified synthesis gas is passed. Any Fischer-Tropsch catalyst may be used, but cobalt-based Fischer-Tropsch catalysts are preferred over iron-based catalysts due to their lower carbon dioxide selectivity. Suitable cobalt Fischer-Tropsch catalysts are known, but preferred catalysts in the process comprise 9 to 20% wt Co supported on a suitable support material. Suitable catalysts therefore include agglomerates, pellets or extrudates comprising metal oxides such as alumina, zinc oxide, titania or silica, or mixtures thereof, on which the catalytically active metal, preferably cobalt, is deposited. In a particularly preferred arrangement, the Fischer-Tropsch catalyst is used in combination with a catalyst carrier suitable for use in a tubular Fischer-Tropsch reactor where the catalyst carrier containing the catalyst is disposed within one or more tubes that are cooled by circulating coolant, such as water under pressure. By “catalyst carrier” we mean a catalyst container, for example in the form of a cup or can, configured to allow a gas and/or liquid to flow into and out of the carrier and through a bed of the catalyst or catalyst precursor disposed within the carrier. Any suitable catalyst carrier may be used. In one arrangement, the catalyst carrier is that described in WO2011/048361, the contents of which are incorporated herein by reference. In an alternative arrangement, the catalyst carrier may include a catalyst monolith as disclosed in WO2012/136971, the contents of which are also incorporated herein by reference. In yet another alternative arrangement, the catalyst carrier may be that disclosed in WO2016/050520, the contents of which are also incorporated herein by reference. In preferred embodiments, the Fischer-Tropsch hydrocarbon synthesis unit comprises a tubular reactor in which catalyst carriers containing a Fischer-Tropsch catalyst are disposed within one or more tubes cooled by a cooling medium.

Typically, a portion of the carbon monoxide is converted in the one or more Fischer-Tropsch reactors to produce a mixture of liquid hydrocarbon products, co-produced water, and a gaseous mixture containing unreacted hydrogen and carbon monoxide, plus carbon dioxide and gaseous light hydrocarbons including methane, ethane, propanes and butanes. The reaction product mixture may be cooled, and the aqueous and liquid hydrocarbon streams separated from the gas mixture using one or more gas-liquid separators. The co-produced water may be separated using known hydrocarbon-water separators. The separated gas mixture, which may be termed “tail gas”, may be used in a number of ways. Preferably a first portion of the tail gas is recycled to the one or more Fischer-Tropsch reactors in a synthesis loop to increase the overall conversion of carbon monoxide to hydrocarbons. The fraction that is recycled to form the loop may be set to control the build-up of inert gases, such as methane, in the Fischer-Tropsch hydrocarbon synthesis unit to an acceptable level. The remaining portion still contains a valuable source of carbon. Accordingly, in the present invention a portion of the tail gas is recycled to the reverse water-gas shift unit via the first derichment vessel containing a derichment catalyst that converts any C2+ higher hydrocarbons present in the second portion of the tail gas to methane. Steam is added to the second portion to provide a suitable steam to carbon ratio for the derichment step. The portion that is not recycled to the reverse water-gas shift unit, which may be termed “purge gas”, may be removed from the process to prevent the build-up of inert gases. The purge gas may be exported as fuel or used within the process in a fired heater or thermal oxidiser to heat feed to the reverse water-gas shift vessel or superheat steam.

Liquid hydrocarbons recovered from the hydrocarbon synthesis unit are subjected to upgrading in an upgrading unit to provide more valuable hydrocarbon products. The upgrading unit may be fed with one or more liquid hydrocarbon streams produced by the hydrocarbon synthesis unit, including but not limited to a molten hydrocarbon wax and a light hydrocarbon condensate, which is liquid at ambient temperature.

Desirably, the hydrocarbon synthesis unit is operated to produce a molten hydrocarbon wax liquid, which is subjected to upgrading treatments in a hydrotreating unit to generate liquid fuels. Accordingly, in some embodiments, at least a portion and preferably all of the liquid hydrocarbon mixture resulting from the hydrocarbon synthesis is fed as a feedstock, in the presence of hydrogen, to an upgrading unit comprising a hydrotreating unit. The hydrotreating unit may perform various conversions such as hydroisomerization, hydrogenation, hydrodeoxygenation, and/or hydrocracking using one or more vessels containing suitable catalysts. Hydrogen is required by the hydrotreating unit. This may be provided by various sources but is desirably provided by an electrolysis unit to minimise carbon dioxide emissions from the process. Accordingly, in some embodiments, a portion of the hydrogen stream from an electrolysis unit is fed to the hydrotreating unit.

The hydrotreating unit may be operated at a temperature generally of between 20° and 450° C., preferably from 250 to 450° C., more preferably from 300 to 450° C. and most preferably between 320 to 420° C.; a pressure of between 0.2 and 15 MPag, preferably between 0.5 and 10 MPag and more preferably from 1 to 9 MPag; a liquid hourly space velocity of between 0.1 and 10 h-1, preferably between 0.2 and 7 h-1 and more preferably between 0.5 and 5.0 h-1, and the hydrogen content may be between 100 and 2000 litres H₂ per litre of feedstock and preferably between 150 and 1500 litres H₂ per litre of feedstock.

The hydrotreating stage may suitably be carried out under conditions such that the conversion per pass of products with a boiling point of greater than or equal to 370° C. into products having boiling points of less than 370° C. is greater than 40% by weight and more preferably at least 50% by weight, so as to obtain middle distillates (gas oil and kerosene) having sufficiently good cold properties (pour point, freezing point) to satisfy the specifications in force for this type of fuel.

The catalysts used in this stage are known. For example, hydroisomerization and hydrocracking can be carried out according to any one of the known processes, using any one of the known catalysts, and it is not limited to a specific process or catalyst. The majority of the catalysts suitable for hydroisomerization/hydro-cracking are of the bifunctional type combining an acid function with a hydrogenating function. The acid function is generally provided via supports of high specific surface area (150 to 800 m2/g generally) exhibiting a surface acidity, such as halogenated (in particular chlorinated or fluorinated) aluminas, phosphorated aluminas, combinations of boron and aluminium oxides, or silicas/aluminas. The hydrogenating function is generally provided either by one or more metals from Group VIII of the Periodic Table of the Elements, such as iron, cobalt, nickel, ruthenium, rhodium, palladium, osmium, iridium and platinum, or by a combination of at least one metal from Group VI, such as chromium, molybdenum and tungsten, and at least one metal from Group VIII. Most conventional hydrocracking catalysts are composed of weakly acidic supports, such as silicas/aluminas. These systems are typically used to produce middle distillates of very good quality. Many catalysts of the hydrocracking market are based on silica/alumina in combination with a metal from Group VIII. These systems have a very good selectivity for middle distillates and the products formed are of good quality. According to one preferred embodiment, the hydroisomerization/hydrocracking catalyst comprises at least one hydro-dehydrogenating element chosen from the noble metals of Group VIII, preferably platinum and/or palladium, and at least one amorphous refractory oxide support, preferably silica/alumina.

The hydrocarbon products recovered from the hydrotreatment unit may be fed to separation apparatus to recover the valuable hydrocarbon products. The separation apparatus may comprise one or more atmospheric distillation columns and optionally one or more vacuum distillation columns that separate the upgrader hydrocarbon off-gas, the naphtha fraction, and preferably at least one kerosene and/or gas oil fraction and a heavy fraction. The heavy fraction generally exhibits an initial boiling point of at least 350° C., preferably of greater than 370° C. This fraction is advantageously recycled to hydrotreatment unit. It may also be advantageous to recycle a portion of the kerosene to the hydrotreatment unit. The gas oil and kerosene fractions may or may not be recovered separately and the cut points may be adjusted to produce the desired hydrocarbon product.

Examples of the present specification are now described with reference to the accompanying figures.

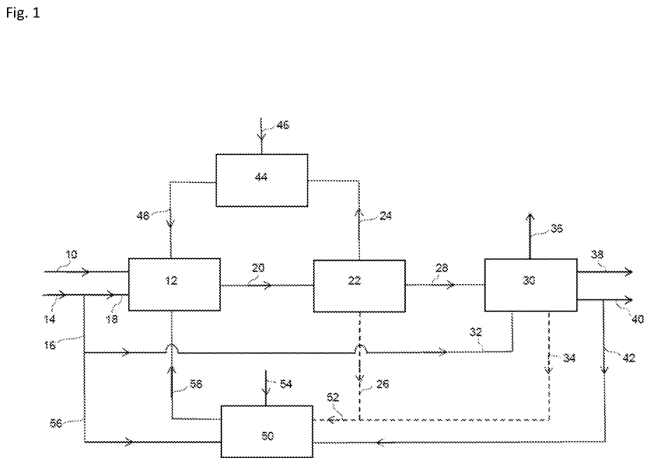

In FIG. 1, a carbon dioxide stream 10, such as a carbon dioxide stream recovered from a flue gas, is fed to a reverse water-gas shift unit 12. The reverse water-gas shift unit comprises an autothermal reverse water-gas shift vessel containing a bed of reverse water gas shift catalyst disposed beneath a burner (not shown). Hydrogen, such as hydrogen produced by an electrolysis unit, is fed to the process via line 14. A portion of the hydrogen is taken from line 14 via line 16 for use downstream and the remaining portion fed via line 18 to the reverse water-gas shift unit 12, where in the autothermal reverse water-gas shift vessel it is subjected to combustion with oxygen and passed with the carbon dioxide 10 through the bed of reverse-water-gas shift catalyst. The reverse water-gas shift reaction takes place over the catalyst forming a synthesis gas comprising carbon monoxide, hydrogen, carbon dioxide and steam. The reverse water-gas shift unit further comprises cooling equipment (not shown) that cools the synthesis gas recovered from the reverse water-gas shift vessel to below the dew point, and a gas-liquid separator that recovers liquid condensate from the cooled synthesis gas to form a dewatered synthesis gas. The reverse water-gas shift unit further comprises a CO₂ removal unit (not shown) to which the dewatered synthesis gas is fed. The CO₂ removal unit operates by means of an amine wash that removes CO₂ from the dewatered synthesis gas to produce a FT syngas consisting essentially of carbon monoxide and hydrogen. The recovered CO₂ from the CO₂ removal unit may be combined with the carbon dioxide fed via line 10 that is fed to the reverse water-gas shift vessel.

The FT syngas is fed from the reverse water-gas shift unit via line 20 to a hydrocarbon synthesis unit 22 comprising one or more Fischer-Tropsch reactors containing a Fischer-Tropsch catalyst. The Fischer-Tropsch reactions take place to form liquid hydrocarbon products, co-produced water and a tail gas stream containing unreacted carbon monoxide and hydrogen, and gaseous hydrocarbons. The hydrocarbon synthesis unit further comprises cooling equipment and gas-liquid separators (not shown) that separate the liquid hydrocarbon products from the co-produced water and tail gas. A portion of the tail gas is recycled to the one of more Fischer-Tropsch reactors. A remaining portion of the tail gas stream is recovered from the hydrocarbon production unit 22 via line 24 for further processing. Liquid hydrocarbon products are fed from the hydrocarbon synthesis unit 22 via line 28 to an upgrading unit 30.

The upgrading unit 30 is also fed with a portion of the hydrogen stream 16 via line 32. The upgrading unit includes a hydrotreater containing a hydrotreating catalyst (not shown) that upgrades the liquid hydrocarbons 28 with the hydrogen fed via line 32 to form fuel mixtures. The upgrading unit 30 further comprises one of more distillation units (not shown) that separate the fuel mixtures into various products. The upgrading unit thereby provides a liquid kerosene stream recovered via line 36, a liquid diesel stream recovered via line 38 and a liquid naphtha stream recovered via line 40. A portion of the liquid naphtha stream is recovered from line 40 via line 42 for further processing.

A first derichment vessel 44 containing a derichment catalyst is fed with the portion 24 of the tail gas recovered from the hydrocarbon synthesis unit 22. Steam is fed to the first derichment vessel via line 46. The derichment catalyst converts C2+ hydrocarbons in the tail gas to methane. The resulting gas mixture containing methane is fed from the derichment vessel 44 via line 48 to the autothermal reverse water-gas shift vessel in the reverse water-gas shift unit 12.

A second derichment vessel 50 containing a derichment catalyst is fed with a portion of naphtha from line 42. Steam is fed to the second derichment vessel via line 54. A portion of the hydrogen stream 16 is also fed to the second derichment vessel via line 56. The derichment catalyst converts C2+ hydrocarbons in the naphtha to methane. The resulting gas mixture containing methane is fed from the derichment vessel 50 via line 58 to the autothermal reverse water-gas shift vessel in the reverse water-gas shift unit 12.

Optionally, in some arrangements, a hydrocarbon synthesis unit hydrocarbon off-gas, shown by dashed line 26 may be recovered from the hydrocarbon synthesis unit 22 and fed to the second derichment vessel 50. Alternatively, or in addition, an upgrader hydrocarbon of-gas shown by dashed line 34 may be recovered from the upgrading unit 30 and fed to the second derichment vessel 50. In this way the naphtha feed to the second derichment vessel may optionally be supplemented with a hydrocarbon off-gas stream that may usefully be de-riched under the same conditions as the naphtha.

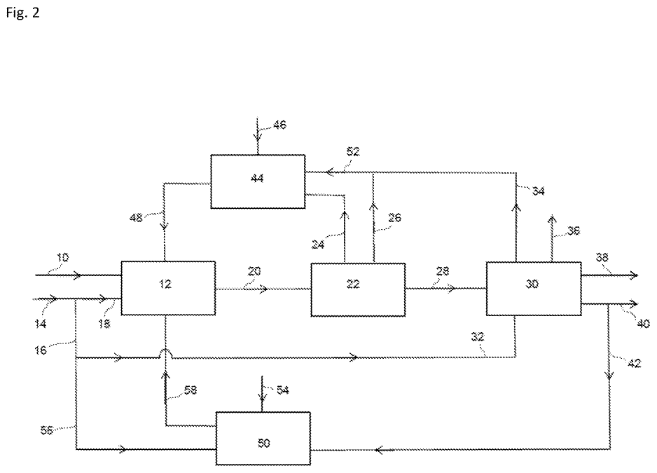

FIG. 2 is similar to FIG. 1, but instead of feeding the off-gas streams 26 and 34 via line 52 to the second derichment reactor 50 along with the naphtha stream 42, the off-gas streams 26 and 34 are combined and fed via line 52 to the first derichment vessel 44 along with the tail gas stream 24. Accordingly, the second derichment vessel 50 is fed only with the naphtha stream via line 42, steam via line 54 and hydrogen via stream 56.

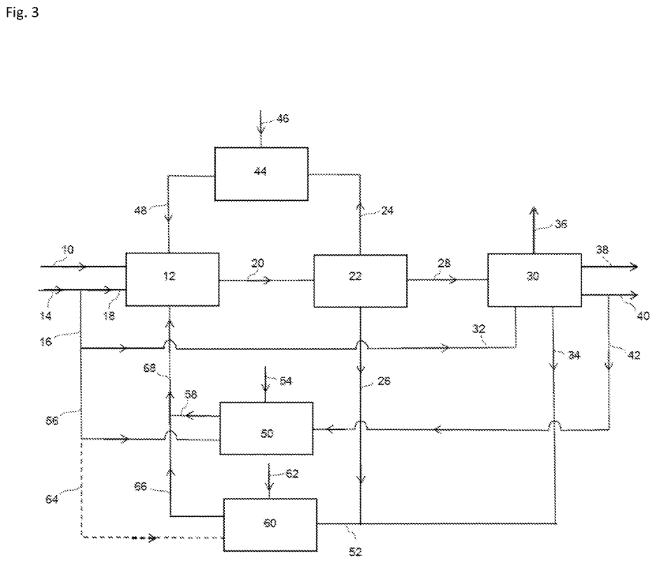

FIG. 3 is similar to FIG. 1, except that there are separate tail gas, off-gas and naphtha derichment vessels. Thus, in FIG. 3, the first derichment vessel is fed only with tail gas via line 24 and steam via line 46, the second derichment vessel 50 is fed only with the naphtha stream via line 42, steam via line 54 and hydrogen via stream 56. Off-gas streams 26 and 34 are combined and fed via line 52 to a third derichment vessel 60 containing a derichment catalyst. Steam is fed to the third derichment vessel via line 62. As illustrated by the dashed line 64, a portion of the hydrogen stream 56 is optionally fed to the third derichment vessel. The derichment catalyst converts C2+ hydrocarbons in the off-gas to methane. The resulting gas mixture containing methane is fed from the derichment vessel 60 via line 66, combined with the gas mixture containing methane in line 58 and fed via line 68 to the autothermal reverse water-gas shift vessel in the reverse water-gas shift unit 22.

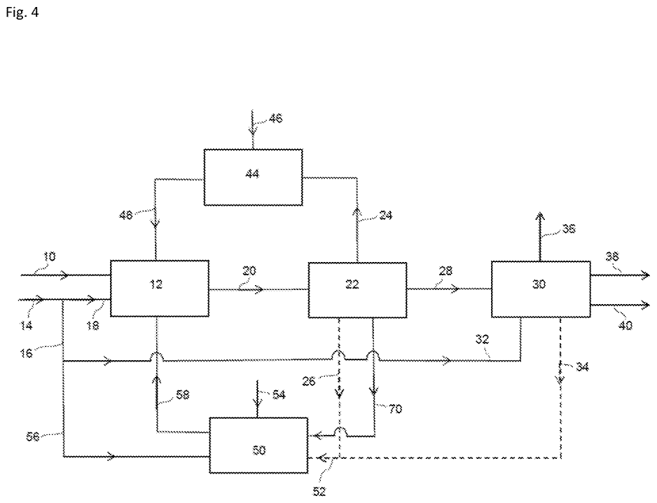

FIG. 4 is similar to FIG. 1, except that the upgrader naphtha stream 42 is omitted and instead a hydrocarbon synthesis unit naphtha stream 70 is fed from the hydrocarbon synthesis unit 22 to the second derichment vessel 50.

The invention will now be further described by reference to the following example in accordance with FIG. 1 without the off-gas feeds 26 and 34 to the second derichment reactor 50.

A flowsheet was modelled to produce 1000 bbl/d of FT crude hydrocarbon product. The operating conditions and compositions of the streams was as follows:

| | | | | | | | | | | |
|---|---|---|---|---|---|---|---|---|---|---|
| Stream | 10 | 18 | 42 | 54 | 56 | 58 | 20 | 24 | 46 | 28 |
| Temperature (° C.) | 25 | 25 | 480 | 250 | 25 | 525 | 40 | 300 | 250 | 515 |
| Pressure (bara) | 30 | 30 | 30 | 40 | 30 | 25 | 35 | 27 | 40 | 25 |
| Flow (te/h) | 10.3 | 2.1 | 2.1 | 3.7 | 0.01 | 5.8 | 15.7 | 2.9 | 1.0 | 3.9 |
| Composition (mol %) | | | | | | | | | | |
| Water | 5.0 | 0.3 | — | 100 | 0.3 | 43.4 | 0.4 | 0.5 | 100 | 23.9 |
| Hydrogen | — | 99.5 | — | — | 99.5 | 10.1 | 65.1 | 17.7 | — | 7.9 |
| Carbon Monoxide | — | — | — | — | — | 0.6 | 29.6 | 11.2 | — | 0.7 |
| Carbon Dioxide | 95.0 | — | — | — | — | 11.4 | 0.5 | 4.4 | — | 9.5 |
| Methane | — | — | — | — | — | 34.5 | 3.3 | 51.9 | — | 50.3 |
| Nitrogen | — | — | — | — | — | — | 1.1 | 10.3 | — | 7.7 |
| Oxygen | — | 0.2 | — | — | 0.2 | — | — | — | — | — |
| Ethane | — | — | — | — | — | — | — | 1.4 | — | — |
| Propane | — | — | 0.3 | — | — | — | — | 1.2 | — | — |
| Butane | — | — | 2.5 | — | — | — | — | 0.7 | — | — |
| Pentane | — | — | 21.9 | — | — | — | — | 0.4 | — | — |
| Hexane | — | — | 29.1 | — | — | — | — | 0.2 | — | — |
| Heptane | — | — | 27.6 | — | — | — | — | 0.1 | — | — |
| Octane | — | — | 17.6 | — | — | — | — | — | — | — |
| Nonane | — | — | 1.0 | — | — | — | — | — | — | — |

The invention provides the following advantages:
1. The process maximises hydrogen and carbon efficiency of the flowsheet by recycling naphtha (and off-gas) in addition to the Fischer-Tropsch tail gas.
2. Industry demand for sustainable aviation fuels results in a preference for high jet-fuel/kerosene product slates. However, higher kerosene yields schemes produce a greater proportion of naphtha than higher diesel yield schemes. If naphtha is not valued, then it may be economically preferable to recycle the naphtha and maximise carbon input into kerosene product.
3. Tail Gas/off-gas/naphtha streams require derichment prior to being fed to the reverse water gas shift unit to prevent carbon fouling of the reactor.

1. A process for synthesising hydrocarbons comprising the steps of: (a) feeding a gas mixture comprising hydrogen and carbon dioxide to a reverse water-gas shift unit to form a crude synthesis gas comprising hydrogen, carbon monoxide carbon dioxide and steam, (b) cooling the crude synthesis gas to condense water and removing water from the crude synthesis gas to produce a feed stream comprising hydrogen and carbon monoxide, (c) passing the feed stream though a hydrocarbon synthesis unit comprising a reactor containing a Fischer-Tropsch catalyst to form a product stream comprising a mixture of liquid hydrocarbons, a co-produced water stream, and a tail gas stream containing hydrogen, carbon monoxide and gaseous hydrocarbons, and (d) upgrading the product stream in an upgrading unit to produce an upgraded product stream, the upgrading unit comprising a hydrotreating unit to perform one or more of hydroisomerization, hydrogenation, hydrodeoxygenation, and hydrocracking to produce the upgraded product stream, wherein a naphtha stream is separated from the product stream or the upgraded product stream, at least a portion of the tail gas stream is fed with steam to a first derichment vessel containing a derichment catalyst to form a first gas mixture containing methane, at least a portion of the naphtha stream is fed with hydrogen and steam to a second derichment vessel containing a derichment catalyst to form a second gas mixture containing methane, wherein the first and second derichment vessels containing derichment catalyst convert C2+ hydrocarbons to methane, wherein the first and second derichment vessels are operated at different conditions to produce the first and second gas mixtures containing methane, and the first and second gas mixtures containing methane are fed to the reverse water gas shift unit.

2. The process according to claim 1, wherein in step (b) carbon dioxide is also removed from the crude synthesis gas.

3. The process according to claim 1, comprising subjecting the gas mixture comprising hydrogen and carbon dioxide to a catalytic or non-catalytic reverse-water-gas-shift reaction.

4. The process according to claim 1, wherein the gas mixture comprising hydrogen and carbon dioxide is subjected to an autothermal reverse-water-gas-shift reaction or an electrically heated reverse-water-gas-shift reaction or a plasma-heated reverse-water-gas-shift reaction.

5. The process according to claim 1, wherein the reverse water-gas shift unit comprises an autothermal shift reactor in which hydrogen and carbon dioxide are fed to a burner inside a reverse water-gas shift vessel where they are partially combusted with oxygen to generate a heated gas comprising hydrogen, steam, carbon monoxide and carbon dioxide that passes through a bed of reverse water gas shift catalyst disposed downstream of the burner.

6. The process according to claim 5, wherein gas mixture comprising carbon dioxide and hydrogen fed to the burner comprises 15 to 50% by volume, preferably 25 to 40% by volume, of carbon dioxide.

7. The A process according to claim 5, wherein the feed gases to the autothermal shift reactor are preheated to a temperature in the range of 400 to 1000° C., preferably 450 to 800° C.

8. The process according to claim 5, wherein the reverse water-gas shift catalyst is a nickel-oxide based catalyst containing 3-20% by weight nickel, expressed as NiO.

9. The process according to claim 1, wherein the hydrogen fed to the reverse water-gas shift unit is a non-fossil fuel based hydrogen stream generated by catalytic or non-catalytic partial oxidation of biomass or plastics, or by electrolysis of water.

10. The process according to claim 1, wherein the carbon dioxide fed to the reverse water-gas shift unit is a carbon dioxide stream recovered from an upstream synthesis gas generation unit, a carbon dioxide stream recovered from an ammonia plant that uses a hydrocarbon or carbonaceous feed, a carbon dioxide stream recovered from a furnace or boiler flue gas, wherein the furnace or boiler is heated by combustion of a carbonaceous fuel, or a carbon dioxide stream separated from air or seawater.

11. The process according to claim 1, wherein the carbon dioxide fed to the reverse water-gas shift unit includes at least a portion of carbon dioxide recycled from downstream of the reverse water-gas shift unit.

12. The process according to claim 1, wherein an upgrader hydrocarbon off-gas stream recovered from the upgrading unit is also fed to the first derichment vessel and/or the second derichment vessel.

13. The process according to claim 1, wherein a hydrocarbon synthesis unit hydrocarbon off-gas stream recovered from the hydrocarbon synthesis unit is fed to the first derichment vessel and/or the second derichment vessel.

14. The process according to claim 1, wherein one or more further derichment vessels are provided for treatment of an upgrader hydrocarbon off-gas stream recovered from the upgrading unit and optionally a hydrocarbon synthesis unit hydrocarbon off-gas stream recovered from the hydrocarbon synthesis unit, with steam to produce a further gas mixture containing methane that is fed to the reverse water gas shift unit.

15. The process according to claim 14, wherein a third derichment vessel containing a derichment catalyst is fed with at least a portion of an upgrader hydrocarbon off-gas stream recovered from the upgrading unit, and optionally a portion of a hydrocarbon synthesis unit hydrocarbon off-gas stream recovered from the hydrocarbon synthesis unit, to produce a further gas mixture containing methane that is fed to the reverse water gas shift unit.

16. The process according to claim 14, wherein, the upgrading unit is configured to produce a light hydrocarbon liquid stream that is recycled to the first, second or one or more further derichment vessels.

17. The process according to claim 1, wherein the first derichment vessel operates with an inlet temperature in the range of 250-650° C., preferably 300-400° C., a steam to carbon molar ratio in the range of 0.1:1 to 5:1 and a pressure in the range of 1.0 to 7.0 MPag, preferably 1.5 to 6.6 MPag.

18. The process according to claim 1, wherein the second derichment vessel operates with an inlet temperature in the range of 400-550° C., a steam to carbon molar ratio in the range of 1:1 to 5:1, a pressure in the range of 1.0 to 7.0 MPag, preferably 1.5 to 6.6 MPag, and with a minimum H₂ content of 0.001 kg H₂ per kg of carbon-containing components in the feed.

19. The process according to claim 14, wherein the one or more further derichment vessels operates with an inlet temperature in the range of 300-500° C., a steam to carbon molar ratio in the range of 1:1 to 5:1, a pressure in the range of 1.0 to 7.0 MPag, preferably 1.5 to 6.6 MPag, and with a minimum H₂ content of 0.001 kg H₂ per kg of carbon-containing components in the feed.

20. The process according to claim 1, wherein the upgrading unit comprises a hydrotreating unit and one or more atmospheric distillation columns and optionally one or more vacuum distillation columns that provide C1-C4 gases, a hydrocarbon off-gas, a naphtha fraction, at least one kerosene and/or gas oil fraction a heavy fraction and optionally a light hydrocarbon liquid stream.

21. A system for performing the process according to claim 1 comprising: (a) a reverse water-gas shift unit configured to be fed with a gas mixture comprising hydrogen and carbon dioxide, that forms a crude synthesis gas comprising hydrogen, carbon monoxide carbon dioxide and steam, (b) cooling and separation apparatus configured to be fed with the crude synthesis gas that cools the crude synthesis gas to condense water and remove water, and optionally carbon dioxide, from the crude synthesis gas to produce a feed stream comprising hydrogen and carbon monoxide, (c) a hydrocarbon synthesis unit comprising a reactor containing a Fischer-Tropsch catalyst configured to be fed with the feed stream to form a product stream comprising a mixture of liquid hydrocarbons, a co-produced water stream, and a tail gas stream containing hydrogen, carbon monoxide and gaseous hydrocarbons, and (d) an upgrading unit configured to be fed with the product stream to produce an upgraded product stream, the upgrading unit comprising a hydrotreating unit to perform one or more of hydroisomerization, hydrogenation, hydrodeoxygenation, and hydrocracking to produce the upgraded product stream, wherein separation equipment is provided to separate a naphtha stream from the product stream or the upgraded product stream, a first derichment vessel containing a derichment catalyst is configured to be fed with at least a portion of the tail gas stream and steam, a second derichment vessel containing a derichment catalyst is configured to be fed with a portion of the naphtha stream, steam and hydrogen, in each case to provide a gas mixture containing methane, wherein the first and second derichment vessels containing derichment catalyst are configured to convert C2+ hydrocarbons to methane, wherein the first and second derichment vessels are configured to operate at different conditions to produce the gas mixtures containing methane, and wherein the first and second derichment vessels are coupled to the reverse water-gas shift unit to feed the gas mixtures containing methane from the first and second derichment vessels to the reverse water gas shift unit.
